(19) United States
(12) Patent Application Publication
(10) Pub. No.: US 2014/0286054 A1
(43) Pub. Date: Sep. 25, 2014

(54) INDUCTIVE COMPONENT AND USE

(71) Applicant: BRUSA Elektronik AG, Sennwald (CH)

(72) Inventor: Axel Krause, Nesslau (CH)

(73) Assignee: BRUSA Elektronik AG, Sennwald (CH)

(21) Appl. No.: 14/353,768

(22) PCT Filed: Oct. 19, 2012
(86) PCT No.: PCT/IB2012/055722

§ 371 Date: Apr. 25, 2014

Related U.S. Application Data
(60) Provisional application No. 61/551,002, filed on Oct. 25, 2011.

(30) Foreign Application Priority Data
Oct. 25, 2011 (EP) 11186570

(51) Int. Cl. H01F 27/34; H01F 27/28

(52) U.S. Cl. CPC H01F 27/346; H01F 27/28
USPC 363/16; 336/199; 363/126; 363/131

(57) ABSTRACT

An inductive component (1a . . . 1e) with at least two coils (2 . . . 4b) in a closed main magnetic circuit (5a . . . 5j) for guiding a magnetic main flux (Φ_{H}) penetrating all coils (2 . . . 4b) is specified. The inductive component furthermore comprises a leakage field guide component (6a . . . 8c) or a plurality of leakage field guide components (6a . . . 8c), wherein a leakage field guide component (6a . . . 8c) is arranged between two coils (2 . . . 4b) in each case, separated by two air gaps (E . . . J) from the main magnetic circuit and intended for guiding a magnetic leakage flux Φ_{S} different from the main flux Φ_{H}. The main magnetic circuit (5a . . . 5j) and/or the leakage field guide components (6a . . . 8c) consist of a magnetically isotropic material. Furthermore, the invention relates to a use of a choke (1a . . . 1e) with leakage field guide component (6a . . . 8c) for guiding a leakage flux (Φ_{S}) arising in the choke (1a . . . 1e) as a PFC (Power Factor Correction) choke.

This application is a 35 U.S.C. 371 national-phase entry of PCT International application no. PCT/IB2012/055722 filed on Oct. 19, 2012 and also claims benefit of priority to prior European application no. EP11186570 filed on Oct. 25, 2011, and also claims priority as a non-provisional of U.S. provisional application Ser. No. 61/551,002 filed on Oct. 25, 2011, and both European application no. EP11186570 and U.S. provisional application Ser. No. 61/551,002, as well as parent PCT International application no. PCT/IB2012/055722, are all incorporated herein by reference in their entireties for all intents and purposes, as if identically set forth in full herein.

The invention relates to an inductive component comprising at least two coils in a closed main magnetic circuit for guiding a magnetic main flux penetrating all coils, the main magnetic circuit comprising a central shank and at least one outer shank and the at least two coils being arranged on the central shank. The inductive component furthermore comprises a leakage field guide component or a plurality of leakage field guide components, wherein a leakage field guide component is arranged between two coils in each case, separated by two air gaps from the main magnetic circuit and intended for guiding a magnetic leakage flux different from the main flux, and wherein one air gap faces the central shank and one air gap faces the outer shank. Furthermore, the invention relates to a use of a choke with a leakage field guide component for guiding a leakage flux arising in the choke.

“Inductive components” of the type mentioned are, in particular, to be understood as meaning chokes and transformers.

Chokes are inductive passive components which are used predominantly in the field of power supplies of electrical and electronic devices or systems, as well as in power electronics, for damping undesired frequencies or for energy storage. Chokes include at least one winding of a current conductor, the coil, which is often provided on a magnetically conductive core for guiding the magnetic flux.

Actually, the invention relates, among other things, to a choke with at least two coils, thus a coupled choke. Principally, a choke of this type is identical to a transformer which likewise has a plurality of coils in a main magnetic circuit. Thus, a coupled choke and a transformer differ mainly in terms of the wiring and intended use thereof. Principally, a coupled choke may however, also be used as a transformer and vice versa.

In addition to the main magnetic flux which penetrates all of the coils, a leakage flux also arises in an arrangement with a plurality of coils, which leakage flow does not penetrate all coils or windings. This leakage flow causes eddy currents in the windings which thermally load the inductive component and therefore are undesirable for the most part. For this reason, a few solutions for guiding a leakage flux have already been suggested in the prior art.

For example, JP H08-222441A discloses a high-frequency choke with reduced leakage flux and reduced eddy currents. Grooves are incorporated into a cylindrical core, in which grooves the coils of the choke are arranged. In addition, a pot-shaped body for conducting the magnetic flux is provided. The path for the magnetic main flux is interrupted by one air gap in each case like the path for the leakage flux. The leakage and main inductances are therefore of a similar size.

Furthermore, DE 10246543A1 discloses a coil arrangement with a first coil which coaxially surrounds a second coil leaving a leakage gap. Furthermore, the coil arrangement comprises a leakage flux guide arrangement with a leakage flux guide cylinder arranged in the leakage gap and coaxially surrounding the second coil and with at least one leakage flux guide yoke arranged at the ends of the coils and extending in the radial direction. The coils are in this case arranged in the same plane and a leakage flux is guided axially, that is to say in a direction parallel to the rotational axis of the two coils.

Yet further, JP S59-022305A discloses a core for a choke with at least two main paths and two leakage field guide components for guiding the leakage flux, in order to reduce the eddy current losses. The core for guiding the main flux has two E-shaped parts. The path for the magnetic main flux is interrupted by one air gap in each case like the path for the leakage flux. The leakage and main inductances are therefore of a similar size.

Moreover, DE 10135599A1 discloses an application possibility for a coupled choke, namely a switched-mode power supply with power factor correction, as well as a coil therefor. Two inductances connected in series are here arranged on a coil body and a common core. The coils are arranged in different chambers of the coil body. An empty chamber, that lies in the region of the air gap of the core, is arranged between the two inductances.

In addition, NL 43681C discloses a leak transformer to be used for fluorescent lamps. The transformer comprises a leakage field guide component arranged between two coils, separated by two air gaps from the main magnetic circuit.

Furthermore, EP 0551555A discloses a vehicle mounting transformer comprising a shell type iron core, an input side winding and output side windings wound around the iron core in a magnetically inductive relationship relative to each other. The transformer furthermore comprises a magnetic member assembly with air gaps disposed between the input and output side windings and a second magnetic member assembly disposed between the output side windings for a magnetically loose coupling therebetween. The second magnetic member assembly comprises air gap-less magnetic member disposed within the space surrounded by the iron core and an insulating member insulatingly supporting the air gap-less magnetic member relative to the iron core and the windings.

Moreover, DE 8633338U1 discloses a leakage transformer, particularly to be used for a magnetron of a microwave oven, comprising a magnetic core package and stray field package and a primary coil and a secondary coil as main coils.

Finally, EP 0142207A1 a leakage transformer with primary coils and secondary coils being mounted on a centre leg of a pot core transformer, wherein the pot core transformer is fully closed apart from one or a few through holes permitting lead wires for the coils to be fed out. An air gap is provided in the centre leg and a magnetic shut is provided between the primary coils and the secondary coils. The air gap and the magnetic shunt together define the coupling factor between the primary and secondary coils.

It is an object of the invention to specify an improved inductive component. In particular, the mentioned disadvantages of conventional inductive components should be overcome. Furthermore, an advantageous use of a choke with a leakage field guide component for guiding a leakage flux arising in the choke should be specified.

This object of the invention is achieved with an inductive component of the type mentioned at the beginning, wherein the main magnetic circuit and/or the leakage field guide components consist of a magnetically isotropic material, in particular ferrite.

This object of the invention is furthermore achieved with a use of a choke with a leakage field guide component for guiding a leakage flux arising in the choke as a PFC (Power Factor Correction) choke, particularly if the choke has the above-mentioned features.

The following advantages may result from the invention:
The leakage flux remains in the inductive component
The leakage flux is guided around the coils and therefore does not cause any eddy currents in the windings. Conventional common-mode chokes for example by contrast would not withstand the thermal load in the case of strong current loading of the choke.
The leakage flux can be dosed well by means of the choice of the geometric dimensions of the leakage field guide ring.

By use of a magnetically isotropic material, in particular the eddy current losses in the main magnetic circuit and/or in the leakage field guide components may be reduced.

Advantageous configurations and developments of the invention result also from the description in conjunction with the figures, or are disclosed by the same.

It is beneficial if the main magnetic circuit is constructed as a hollow body with a pin guided through the hollow space and provided as central shank. As a result, the main magnetic circuit may be produced in a simple manner.

It is beneficial in this context if the leakage field guide component is constructed in an annular manner. As a result, the assembly of a leakage field guide component can take place in a simple manner in that the same is pushed onto the pin constructed as central shank.

It is advantageous if the main magnetic circuit and/or the leakage field guide component and/or the coils is/are constructed in a rotationally symmetrical manner. As a result, the components mentioned may be produced in a simple manner.

It is particularly advantageous if the leakage field guide component and the coils are arranged axially one behind the other, in sequence. As a result, the assembly of the inductive component is very simple as the coils and the leakage field guide components need merely to be pushed onto the pin constructed as a central shank in an alternating manner.

It is particularly advantageous in this context if the coils project beyond the leakage field guide components in an axial projection. Consequently, the air gap towards the central shank and the air gap towards the outer shank result in a simple manner.

It is additionally advantageous if one of the coils is divided and the two components, in particular halves, are in each case arranged at the end of a stack formed by the other coils and the leakage field guide components. An advantageous construction of the magnetic fluxes results therefrom.

It is furthermore advantageous if the leakage field guide component is constructed for a radial guiding of the leakage flux. A compact structure of the inductive component as a whole results therefrom.

It is beneficial if the leakage field guide component is constructed as a separate part. As a result, the leakage field guide component may be produced easily, in particular also from a different material than the main magnetic circuit.

It is beneficial if the leakage field guide component is built from a plurality of annular segments. As a result, the production of the leakage field guide components is simplified, as the individual components are only relatively small. In addition, the annular segments may be pushed subsequently between the coils into chambers of the coil body provided therefor.

It is furthermore beneficial if the leakage field guide component is tangentially flattened on one side. As a result, the inductive component according to the invention may be mounted on a planar substrate in a simple manner.

It is furthermore beneficial if the outer contour of the leakage field guide component follows the internal surface of the outer shank of the main magnetic circuit and/or the outer contour thereof at a constant distance. As a result, the resulting air gap is overall of the same size.

It is beneficial for the use according to the invention as a PFC choke, if the PFC choke is arranged between a single- or multiple-phase alternating current network and a rectifier or between a direct-current network and an inverter. Due to the specific arrangement, the PFC choke has the effect of a common-mode choke. The main inductance in this case acts on the common mode portions of the signal and the leakage inductance acts on the alternating portions of the same.

It is advantageous in this case, if each phase of the alternating-current network is connected in the same manner to one coil in each case of the PFC choke. It is also advantageous in this context if the coils of the choke are wound in the same direction. In this manner, the PFC choke can be inserted into a circuit well, particularly also subsequently.

It is furthermore advantageous if a choke with two coils is connected to an inverter comprising two half bridges of a DC/DC converter, e.g. of a boost converter, whereby:
the two coils are connected to a coil with centre tapping in that the end of the one coil is connected to the beginning of the other coil and this point is connected at the input of the DC/DC converter and whereby
at each bridge point of a half bridge, the respectively free coil end of a coil is connected.
   Only small reactions on the input side of the DC/DC converter result due to this design.

The above configurations and developments of the invention may be combined in any desired manner.

The present invention is described in more detail below on the basis of the exemplary versions specified in the schematic figures of the drawing. In the figures:

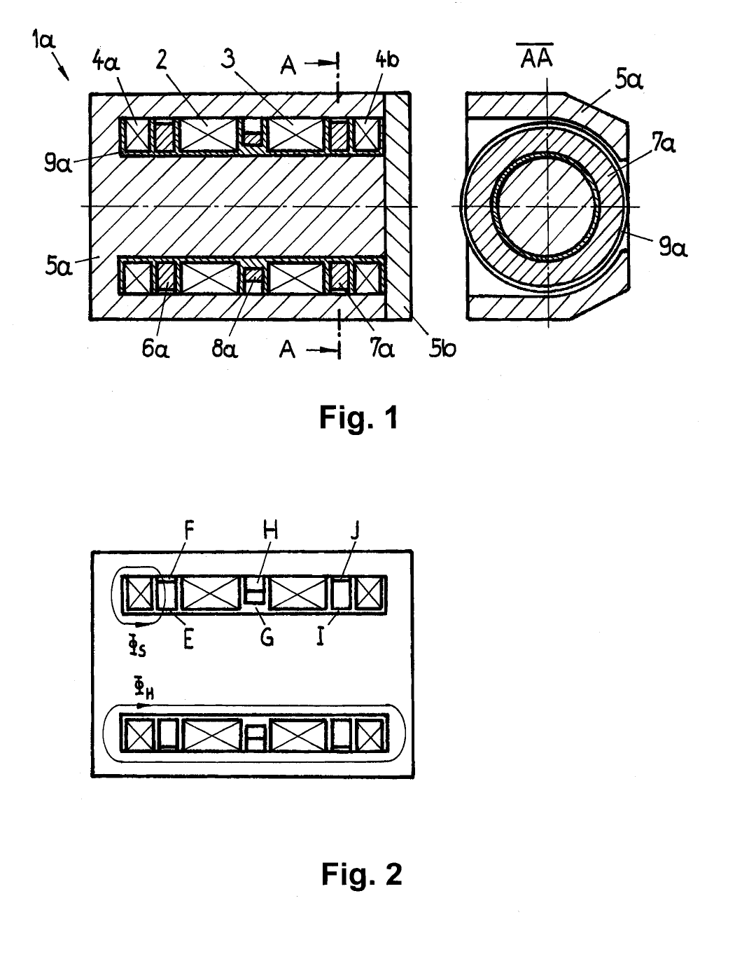

FIG. 1 shows a first variant of an inductive component according to the invention in a longitudinal and cross section;

FIG. 2 shows the inductive component from FIG. 1 with the main and leakage fluxes drawn in;

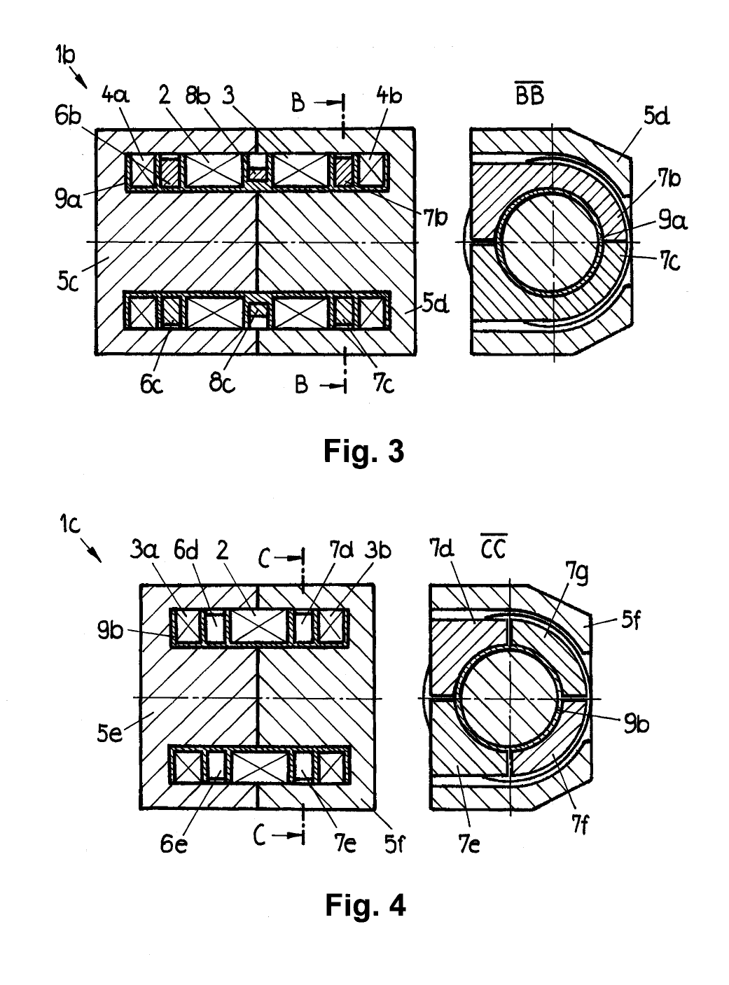

FIG. 3 shows a further variant of an inductive component according to the invention with leakage field guide components having two annular segments in each case;

FIG. 4 shows a further variant of an inductive component according to the invention with leakage field guide components having four annular segments in each case and only two coils (one of which is divided);

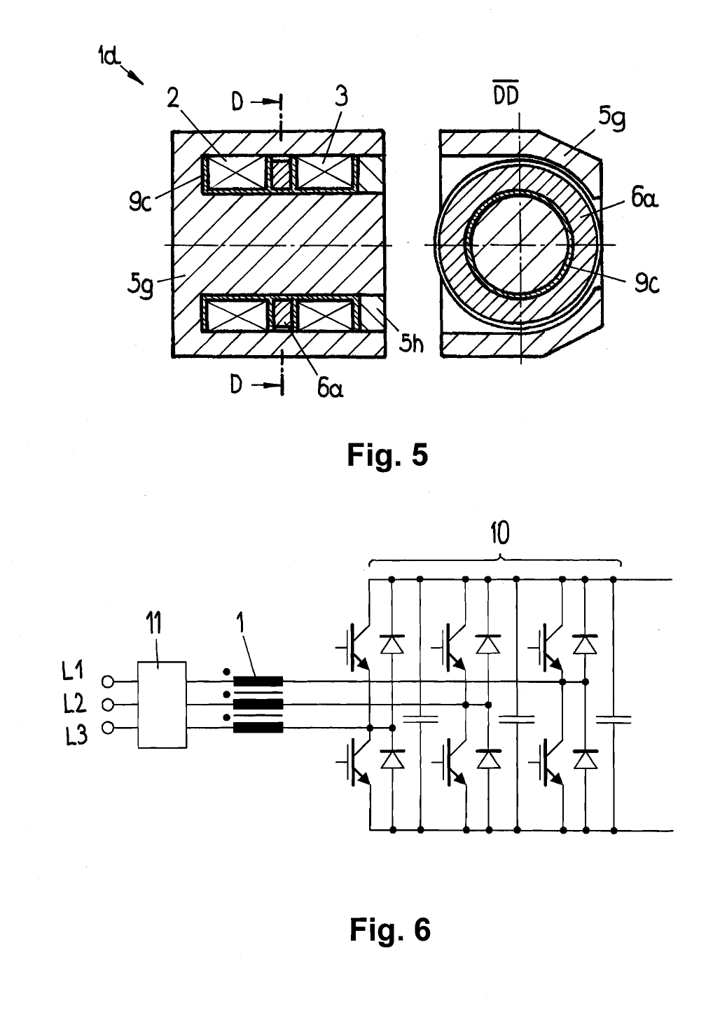

FIG. 5 shows a further variant of an inductive component according to the invention with two undivided coils and a main magnetic circuit divided at the ends;

FIG. 6 shows a first example for the use of a choke with a leakage field guide component as PFC choke;

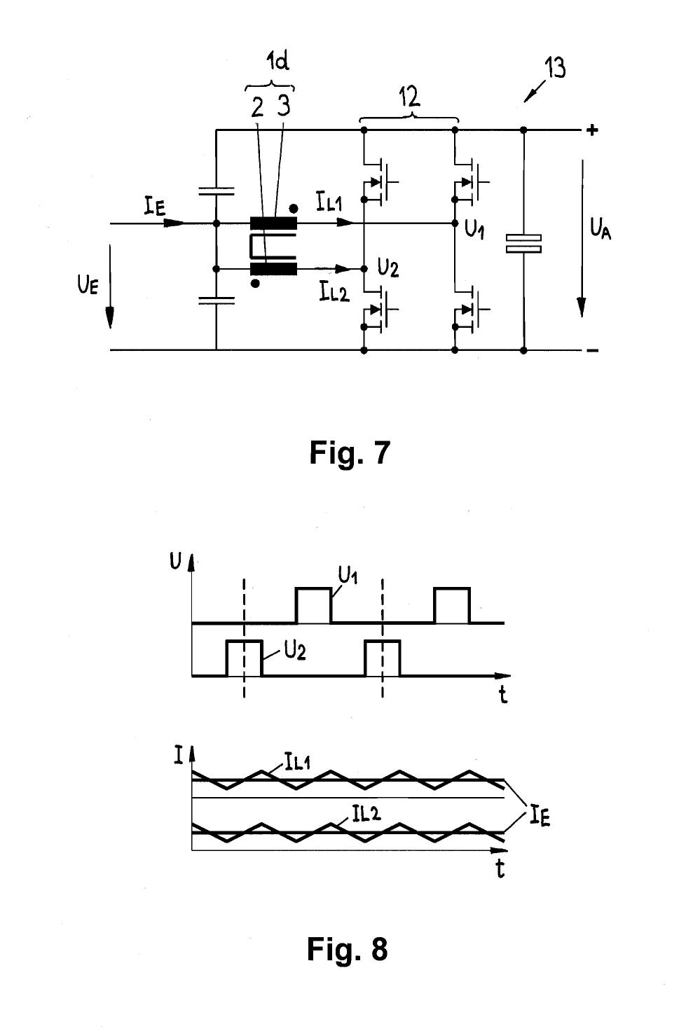

FIG. 7 shows a second example for the use of a choke with a leakage field guide component as a coupled choke in a DC/DC converter;

FIG. 8 shows the temporal course of representative voltages and currents in the circuit illustrated in FIG. 7 in a first operating state;

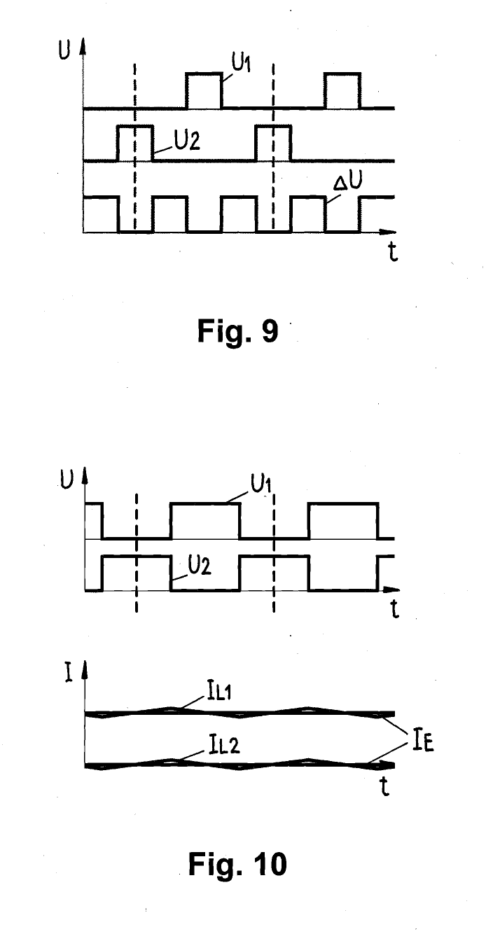

FIG. 9 shows the temporal course of the differential voltage acting due to the choke from FIG. 7 in a first operating state;

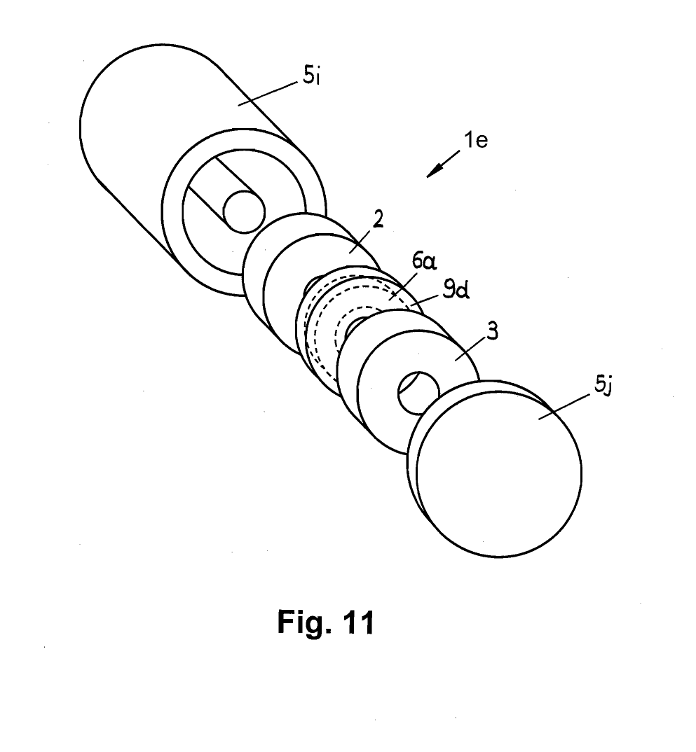

FIG. 10 shows the temporal course of representative voltages and currents in the circuit illustrated in FIG. 7 in a second operating state; and,

FIG. 11 shows a main magnetic circuit constructed as a hollow cylinder with an axially arranged cylindrical pin.

In the figures, identical and similar parts are provided with identical reference numbers. Functionally similar elements and features—insofar as nothing else is specified—are provided with identical reference numbers but different indices.

FIG. 1 shows a first variant of a choke 1a according to the invention in a longitudinal section (left) and in section AA (right). In addition, the choke 1a is also illustrated in FIG. 2, but without shading there for the sake of better presentability of the magnetic fluxes. In the following, the invention is explained on the basis of a choke. The disclosed teaching may of course be applied without limitation to other inductive components of the type mentioned at the beginning, particularly to transformers.

The choke 1a comprises a first coil 2, a second coil 3 and a third coil divided into two components 4a and 4b in a closed main magnetic circuit 5a, 5b for guiding a magnetic main flux Φ_{H} penetrating all of the coils 2 . . . 4b. The two parts 4a and 4b of the third coil together have just as many coils as the first coil 2 or the second coil 3 in each case. It would also be conceivable however to understand the two components 4a and 4b as separate coils, as a result of which the choke 1a would comprise four coils.

A leakage field guide component 6a . . . 8a is arranged between two coils 2 . . . 4b in each case, which is separated from the main magnetic circuit by two air gaps E . . . J and is intended for guiding a magnetic leakage flux Φ_{S} differently from the main flux Φ_{H}.

The main magnetic circuit 5a . . . 5h and/or the leakage field guide components 6a . . . 8c are of a magnetically isotropic material, in particular of ferrite.

The leakage field guide components 6a . . . 8a are annularly constructed and in the actual example furthermore rotationally symmetrical, like the coils 2 . . . 4b.

The main magnetic circuit 5a, 5b comprises a cylindrical pin provided or constructed as a central shank, around which the coils 2 . . . 4b and the leakage field guide components 6a . . . 8a are arranged, and also two outer shanks for guiding the main flux Φ_{H}. Alternatively, it would also be conceivable that the main magnetic circuit is constructed as a hollow body with a pin guided through the hollow space. In particular, this could be constructed rotationally symmetrically and therefore comprise a hollow cylinder with an axially arranged cylindrical pin (see FIG. 11).

Furthermore, the leakage field guide components 6a . . . 8a and the coils 2 . . . 4b are arranged axially sequentially, behind one another, the two components 4a and 4b being positioned in each case at the end of a stack formed by the other coils 2, 3 and the leakage field guide components 6a . . . 8c.

As may be readily seen from FIG. 1, the leakage field guide components 6a . . . 8a are constructed as separate components, actually as rotationally symmetrical rings, and thus for a radial guiding of the leakage flux Φ_{S}. The term “radial” in this context is to be understood broadly and not merely limited to rotationally symmetrical bodies. For example, the leakage field guide components could also be constructed as rectangular rings and be arranged about a rectangular central section of the main magnetic circuit.

Furthermore, it may readily be seen in the section AA that the coils 2 . . . 4b project beyond the leakage field guide components 6a . . . 8a in an axial projection. Consequently, the air gaps E, G, I towards the central shank and the air gaps F, H, J towards the outer shank result in a simple manner.

In the depicted example, the coils 2 . . . 4b and the leakage field guide components 6a . . . 8a are embedded into a holder 9a which on the one hand facilitates a correct positioning of the components mentioned with respect to one another and also the installation of the module formed from the coils 2 . . . 4b, the leakage field guide components 6a . . . 8a and the holder 9a in the main magnetic circuit 5a, 5b. Preferably, the holder 9a is of plastic and is for example produced in an injection moulding process. In this case, the coils 2 . . . 4b and the leakage field guide components 6a . . . 8a can be overmoulded at the same time or the same are installed later on the finished holder 9a.

FIG. 3 shows a variant of a choke 1b according to the invention which is very similar to the choke 1a shown in FIG. 1. In contrast however, the leakage field guide components are constructed from two annular segments 6b . . . 8c and the contour of the outer shank of the main magnetic circuit is adapted so that the outer leakage air gap is the same size at every point. In addition, the main magnetic circuit is divided at another point and is formed by the two components 5c and 5d.

FIG. 4 shows a further variant of a choke 1c according to the invention, which is very similar to the choke 1a shown in FIG. 1. In contrast however, this choke only comprises a first coil 2 and a second coil divided into two components 3a and 3b. The main magnetic circuit formed from the two components 5e and 5f is therefore somewhat shorter. In addition, the leakage field guide components are constructed from four annular segments 6d . . . 7g, as depicted in cross section CC.

FIG. 5 finally shows a yet further variant of a choke 1c according to the invention, which is very similar to the choke 1a shown in FIG. 1. This choke merely comprises a first coil 2 and an undivided second coil 3, however. In addition, the main magnetic circuit is divided at the end and is formed by the two components 5g and 5h.

Of course, the features illustrated in the FIGS. 1 to 5 or mentioned in the description may be combined with one another as desired. For example, the main magnetic circuit of choke 1a in FIG. 1 could be divided as in FIG. 5, or the leakage field guide components 6d . . . 7g divided into four segments from FIG. 4 may also be used for the choke 1b in FIG. 3, etc.

FIG. 6 shows how a choke 1 with a leakage field guide component used for guiding a leakage flux Φ_{S} arising in the choke 1 may be used as a PFC (Power Factor Correction) choke. Actually, the PFC choke 1 in FIG. 6 is arranged between a multiple-phase alternating-current network and a rectifier 10. In this case, each phase L1, L2, L3 of the alternating-current network is connected in the same manner to one coil in each case of the PFC choke 1. The rectifier 10 is an active rectifier with a design which is known per se. In FIG. 6, an optional EMC (Electromagnetic Compatibility) filter 11 is furthermore connected upstream of the PFC choke 1.

Due to the special arrangement, the PFC choke 1 has the effect of a common-mode choke. The main inductance in this case acts on the common mode portions of the PWM signal and the leakage inductance acts on the push-pull or differential portion of the same. In the case of the use of a symmetrical PWM (Pulse Width Modulation), the double PWM frequency results as an additional advantage for the high-frequency current ripple.

Preferably, the choke 1 has the features according to the invention, that is to say comprises at least two coils 2 . . . 4b in a closed main magnetic circuit 5a . . . 5h for guiding a magnetic main flux Φ_{H} penetrating all of the coils 2 . . . 4b. The main magnetic circuit 5a . . . 5h comprises a central shank and at least one outer shank, and the at least two coils 2 . . . 4b are arranged on the central shank. Furthermore, the choke 1 comprises a leakage field guide component 6a . . . 8c or a plurality of leakage field guide components 6a . . . 8c, a leakage field guide component 6a . . . 8c being arranged between two coils 2 . . . 4b in each case, separated by two air gaps E . . . J from the main magnetic circuit and intended for guiding a magnetic leakage flux Φ_{S} different from the main flux Φ_{H}, and one air gap E, G, I facing the central shank and one air gap F, H, J facing the outer shank. The coils 2 . . . 4b of the choke 1a . . . 1d are in this case wound in the same direction. Advantageously, the choke 1 is furthermore realised like the choke 1a . . . 1d illustrated in the FIGS. 1 to 5.

In the example shown in FIG. 6, the PFC choke 1 is arranged between a multiple-phase alternating current network L1, L2, L3 and a rectifier 10. Equivalently, the PFC choke 1 may be arranged between a single-phase alternating-current network and a rectifier. Furthermore, the choke 1 may also be arranged between a direct-current network and an inverter.

FIG. 7 shows a further example of how a choke with a leakage field guide component for guiding a leakage flux Φ_{S} arising in the choke may be used as a storage choke in a DC/DC converter—here as a boost converter. In this example, it is assumed that the choke is realised just like the choke 1d illustrated in FIG. 5. Thus, a very high main inductance results. The actual storage chokes by contrast result due to the leakage inductance. Of course, another choke may also be used with a leakage field guide component however.

Actually, the two coils 2 and 3 of the PFC choke 1d are connected to the inverter 12 of a DC/DC converter 13 comprising two half bridges, wherein
at each bridge point, one coil end of each coil 2, 3 is connected,
the other coil ends are connected to one another and
the coils 2, 3 are arranged in the opposite manner in the main magnetic circuit 5g, 5h.

The function of the DC/DC converter 13 illustrated in FIG. 7 is explained in the graphs illustrated in the FIGS. 8 to 10.

FIG. 8 shows the temporal courses of the voltages U1 and U2 at the bridge points of the inverter 12, the currents IL1 and IL2 through the coils 2 and 3 of the choke 1d and also the input current IE into the DC/DC converter 13 in a first operating state. In FIG. 8, it can well be seen that due to the phase-offset control of the half bridges of the inverter 12, a current ripple with double PWM frequency results.

FIG. 9 shows how the differential voltage ΔU acting due to the choke 1d results from the two bridge voltages U1 and U2. In FIG. 9, it can well be seen that the differential voltage ΔU and therefore also the choke currents IL1 and IL2 have a doubled frequency compared to the voltages U1 and U2. For this reason, the leakage inductance of the choke 1d can be chosen to be comparatively small.

FIG. 10 shows the parameters illustrated already in FIG. 8, but this time in a second operating state of the DC/DC converter 13. In FIG. 10, it can well be seen that in this case, the ripple of the input current IE becomes practically zero in the case of symmetrical control (50% PWM) of the inverter 12. In this specific operating state, the current ripple is determined by the main inductance, which is much larger compared to the leakage inductance, and therefore has the same frequency as the voltages U1 and U2.

FIG. 11 shows another variant of a choke 1e according to the invention in oblique view. The choke 1e is similar to the choke 1d shown in FIG. 5. In contrast, the main magnetic circuit 5i, 5j is constructed as a hollow body with a pin guided through the hollow space. In particular, the main magnetic circuit comprises a hollow cylinder with an axially arranged cylindrical pin 5i and a cover 5j. Furthermore, the choke 1e comprises a first coil 2, a second coil 3 and a leakage field guide component 6a in a holder 9d. Preferably, the holder 9d is of plastic and is for example produced in an injection moulding process covering the leakage field guide component 6a. FIG. 11 shows an example with two coils 2, 3 and a cylindrical magnetic circuit 5i, 5j. It would also be conceivable however to make a polygon magnetic circuit and/or provide more than two coils.

Finally, it is noted that the illustrations are not necessarily to scale and inductive components of the type mentioned at the beginning may also have other proportions in the context of the invention. Also, the circuit variants illustrated only constitute a portion of the wide range of application possibilities of a choke with a leakage field guide component. The person skilled in the art may easily implement further options.

### REFERENCE LABELS LIST

1a . . . 1e Inductive component (choke, transformer)
2 First coil
3 Second coil
3a, 3b Divided second coil
4a, 4b Divided third coil
5a . . . 5j Main magnetic circuit
6a . . . 6e First leakage field guide component
7a . . . 7e Second leakage field guide component
8a . . . 8e Third leakage field guide component
9a . . . 9d Holder
10 Rectifier
11 EMC filter
12 Inverter
13 DC/DC converter
Φ_{H} Main flux
Φ_{S} Leakage flux
ΔU Differential voltage
E, G, I Air gap towards the central shank
F, H, J Air gap towards the outer shank
I Current
IE Input current
IL1, IL2 Choke currents
t Time
U Voltage
U1, U2 Bridge voltages
UA Output voltage
UE Input voltage

What is claimed is:

1-18. (canceled)

19. An inductor assembly comprising:
a closed main magnetic circuit;
said main magnetic circuit including a central shank;
said main magnetic circuit including at least one outer shank;
at least two coils arranged around said central shank;
at least one leakage field guide arranged between said at least two coils, said at least one leakage field guide being separated from said main magnetic circuit by at least two gaps, a first one of said at least two gaps being between said at least one leakage field guide and said central shank, and a second one of said at least two gaps being between said at least one leakage field guide and said at least one outer shank; and,
at least one of said main magnetic circuit and said leakage field guide are made of a magnetically isotropic material.

20. An inductor assembly as claimed in claim 19 further comprising:
said main magnetic circuit has a hollow body; and,
said central shank has a pin through said hollow body.

21. The inductor assembly as claimed in claim 19 wherein:
said at least one leakage field guide has an annular form.

22. The inductor assembly as claimed in claim 19 wherein:
said main magnetic circuit has a rotationally symmetric construction.

23. The inductor assembly as claimed in claim 19 wherein:
said at least one leakage field guide has a rotationally symmetric construction.

24. The inductor assembly as claimed in claim 19 wherein:
said at least one leakage field guide and said at least two coils are disposed in an axial sequence arrangement.

25. An inductor assembly as claimed in claim 24 further comprising:
said at least two coils include a divided coil;
said divided coil having a first part coil;
said divided coil having a second part coil;
said at least two coils include a second coil;
said first part coil, said second part coil, said second coil, and said at least one leakage field guide being arranged in said axial sequence arrangement stacked so that said first part coil and said second part coil are disposed at opposite ends of said stacked axial sequence arrangement.

26. The inductor assembly as claimed in claim 19 wherein:
said at least two coils have a greater radial extent than said at least one leakage field guide.

27. The inductor assembly as claimed in claim 19 wherein:
said at least one leakage field guide has a construction configured to radially guide leakage flux (Φ_{S}).

28. The inductor assembly as claimed in claim 19 wherein:
said at least one leakage field guide has a unitary construction.

29. An inductor assembly as claimed in claim 19 further comprising:
said at least one leakage field guide includes a plurality of annular segments.

30. An inductor assembly as claimed in claim 19 further comprising:
said at least one leakage field guide has a side, said side being tangentially flattened.

31. An inductor assembly as claimed in claim 19 further comprising:
said at least one outer shank has an internal surface;
said at least one leakage field guide has an outer contour, said outer contour following said internal surface spaced at a constant distance.

32. An inductor assembly as claimed in claim 19 further comprising:
said at least one outer shank has a shank outer contour;
said at least one leakage field guide has an guide outer contour, said guide outer contour following said shank outer contour at a constant distance.

33. The inductor assembly as claimed in claim 19 wherein:
said at least two coils are wound in the same direction.

34. The inductor assembly as claimed in claim 19 wherein:
said at least two coils are arranged to provide a PFC choke.

35. An electrical circuit arrangement comprising:
an alternating current network;
a rectifier;
a PFC choke between said alternating current network and said rectifier, said PFC choke including a closed main magnetic circuit;
said main magnetic circuit including a central shank;
said main magnetic circuit including at least one outer shank;
at least two coils arranged around said central shank;
at least one leakage field guide arranged between said at least two coils, said at least one leakage field guide being separated from said main magnetic circuit by at least two gaps, a first one of said at least two gaps being between said at least one leakage field guide and said central shank, and a second one of said at least two gaps being between said at least one leakage field guide and said at least one outer shank; and,
at least one of said main magnetic circuit and said leakage field guide are made of a magnetically isotropic material.

36. An electrical circuit arrangement as claimed in claim 35 further comprising:
said alternating current network having a plurality of phases, each of said plurality of phases being connected in a similar manner to at least one of said at least two coils.

37. An electrical circuit arrangement comprising:
a direct current network;
an inverter;
a PFC choke between said direct current network and said inverter, said PFC choke including a closed main magnetic circuit;
said main magnetic circuit including a central shank;
said main magnetic circuit including at least one outer shank;
at least two coils arranged around said central shank;
at least one leakage field guide arranged between said at least two coils, said at least one leakage field guide being separated from said main magnetic circuit by at least two gaps, a first one of said at least two gaps being between said at least one leakage field guide and said central shank, and a second one of said at least two gaps being between said at least one leakage field guide and said at least one outer shank; and,
at least one of said main magnetic circuit and said leakage field guide are made of a magnetically isotropic material.

38. An electrical circuit arrangement as claimed in claim 37 further comprising:
said inverter includes half bridges of a DC/DC converter, each of said half bridges having a respective bridge point;
each of said at least two coils has a respective end, each said respective end being mutually electrically connected and electrically connected to an input of said DC/DC converter; and,
said bridge points each respectively have a respective free end of a respective coil of said at least two coils electrically connected thereto.
